(19) United States
(12) Patent Application Publication
(10) Pub. No.: US 2016/0059179 A1
(43) Pub. Date: Mar. 3, 2016

(54) CARBON DIOXIDE REMOVAL SYSTEM

(71) Applicant: Calvin Billings, Lake Charles, LA (US)

(72) Inventor: Calvin Billings, Lake Charles, LA (US)

(21) Appl. No.: 14/837,256

(22) Filed: Aug. 27, 2015

Related U.S. Application Data
(60) Provisional application No. 62/042,547, filed on Aug. 27, 2014.

(51) Int. Cl. B01D 53/14; C01B 3/34

(52) U.S. Cl. CPC B01D 53/1475; B01D 53/1493; C01B 3/34; B01D 2252/10; C01B 2203/0216; C01B 2203/86

(57) ABSTRACT

A process for capture of carbon dioxide from gases comprising using Li4SiO₄ contained in a molten salt mixture at a elevated temperature and recovering the CO₂ captured. Also disclosed is A process for producing hydrogen from hydrocarbons or coal comprising reacting steam and hydrocarbon at conditions that convert them to hydrogen and CO₂; contacting the CO₂ containing gas so formed with Li4SiO₄ contained in a molten salt mixture at an elevated temperature and recovering the CO₂ so captured.

### CROSS REFERENCE TO RELATED APPLICATIONS

This application claims benefit of Provisional Application Ser. No. 62/042,574 filed Apr. 27, 2014, the contents and disclosures of which is incorporated herein by reference in its entirety for all purposes

### BACKGROUND

1. Field of Invention

This invention relates to a process for CO₂ capture from gases.

2. Background

Various amine solutions have been used for decades to absorb CO₂ from other gasses in a scrubber tower. After absorbing CO₂, the amine is then heated by steam to release the CO₂ in a regenerator so that the amine can be recycled to absorb more CO₂. This has served industry well for low gas flows. However, with the issue of global warming, the gas flows from power plants has proven to be too large to economically use amine based processes. Consequently a worldwide search has been conducted by industry, governments and universities for a suitable replacement. About twelve years ago Li₄SiO₄ proved promising and several groups produced papers on its efficacy. The reactions are:

Li₄SiO₄+CO₂→Li₂SiO₃+Li₂CO₃

Li₂SiO₃+CO₂→SiO₂+Li₂CO₃ absorption

Li₂SiO₃+Li₂CO₃→Li4SiO₄+CO₂

SiO₂+Li2CO₃→Li₂SiO₃+CO₂ decomposition

In most all cases the apparatus for testing was done using fixed or fluid beds and using dry powders and pellets. Several problems occurred; water in the flue gas, attrition, and losses from displacement. One paper reported on the use of molten carbonates in a two bed arrangement that absorbed and desorbed by alternately switching the flow. In several of the papers it was reported that doping or coating the Li₄SiO₄ particle with Li₂CO₃, K₂CO₃ or Na₃CO₃ would form a molten film on the particle surface and enable the CO₂ gas to diffuse through the film to the particle for better absorption. For the state of the art see Terasaka, et al, Absorption and Stripping of Co2 with a molten Salt Slurry is a Bubble Column at High Temperature; Chem. Eng. Technology, 29, No. 9,1118-1121; Yamauchi, e al, Absorption and Release of Carbon Dioxide with Various Metal Oxides and Hydroxides, Materials Transactions, Vol. 48, No. 10 (2007), pp 2739-2742; Songolzadeh, et al, Carbon Dioxide Capture and Storage: A General Review on Absorbents, World Academy of Science, Engineering and Technology, Vol. 6 (10-24-2012).

For various reasons these studies by sophisticated entities has failed to produce an acceptable, commercial process to use lithium orthosilicate. This lack of accepted success of the orthosiicate process is illustrated by the announcement in August 2014 of construction of a 240 MW commercial installation costing one billion dollars was announced and it is an amine process. With this amount of capital and operating cost attributed to amine, the process is still economically prohibitive for solving the problem of power plant emissions. The developers of the project are basing the economics on the value of the oil that will be derived from CO₂ injection into an oil reservoir, an option in very limited situations.

The fact that this prior work using lithium orthosilicate was done in the era of 2002-2006 by very sophisticated researchers, and a workable system utilizing this knowledge has not emerged in the past eight years shows the need for an improved process. The present invention is such an improved process.

### SUMMARY

The present invention is premised upon the recognition that CO₂ is absorbed when contacted by a molten carbonate salt containing lithium orthosilicate (Li₄SiO4) in a spray tower or static mixer at 800° to 1200° F. The resulting Li₂CO₃ is regenerated back to Li₄SiO₄ when the temperature of the salt is elevated to 1300° in a fire tube heater, releasing the CO₂ for capture. The process is a simple, low cost process using only two items of commercial equipment, a wet gas scrubber and a salt bath heater.

### DESCRIPTION OF FIGURES

FIG. 1 is a schematic drawing of an embodiment of the process of the invention using a spray tower.

FIG. 2 is a schematic drawing of an embodiment of the process of the invention static mixer.

FIG. 3 is a schematic drawing of an embodiment of the process of the invention adapted for hydrogen production.

### DETAILED DESCRIPTION

This molten salt system offers many advantages over dry, fixed and fluid bed systems, and over a dual bubbling tower. A liquid material is much easier to transport by pump rather than handling solids. The liquid prevents abrasion and attrition losses. Liquid salt replaces the elaborate doping process of the silicate particle with carbonate salts. Equipment is not as complex. Liquid salt transfers heat to the particle faster and more evenly, fixed beds tend to channel gas flow. Salt acts catalytically to speed the reaction. Water in the gas stream has no effect on the reaction.

Only two main items of equipment are required—the absorber tower (or static mixer) and the fire tube heater. The absorber tower converts the liquid into a very fine mist that provides maximum surface area for contact with the gas and at the same time provides minimum pressure drop for the flue gas to flow. A bubbling system could not work on a practical basis as the huge volume of gas would blow the liquid from the vessel, and otherwise would create unacceptable back pressure on the boiler or gas turbine. Further, a bubbling system would require many times the volume of salt that a spray system will use.

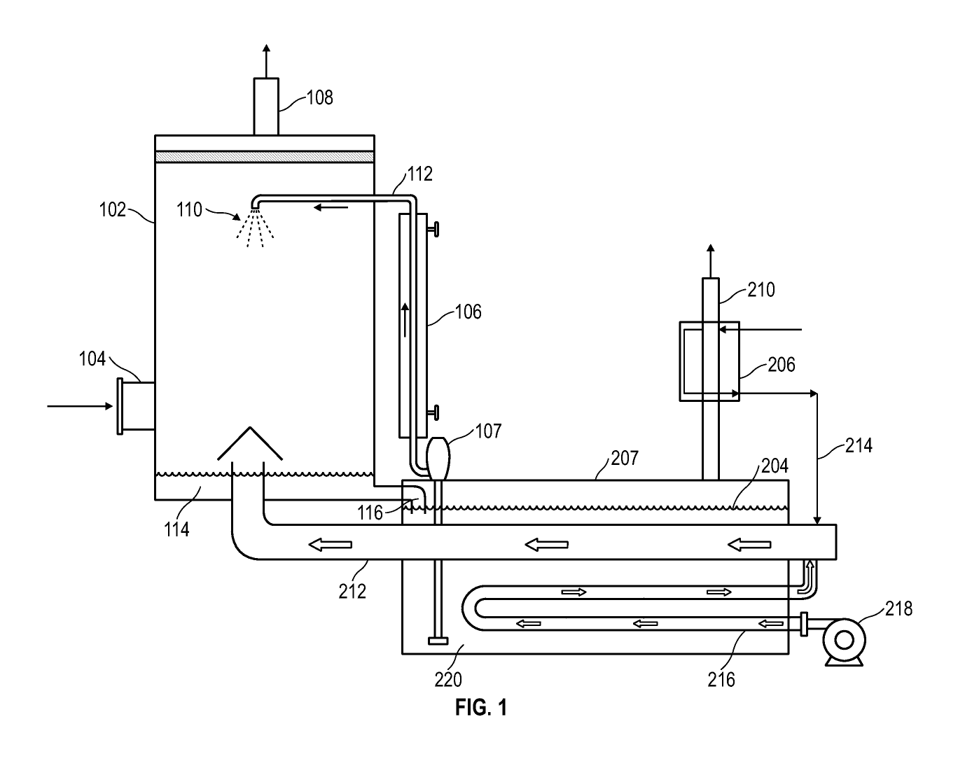

Referring to FIG. 1, a scrubber tower, 102, normally spraying a water solution can be adapted to spray molten salt—a static mixer may be used instead of or in addition to the scrubber as explained more fully below. Flue gas from a boiler, furnace or gas turbine or any gas contaminated with CO₂ enters the bottom of the spray tower, 104, and flows through the fine droplets of molten salt. Li₄SiO₄ within in the salt absorbs the CO₂ and falls to the bottom of the tower and collects in a shallow pool, 114. A salt bath heater, 202, is joined to the tower in such a way that the salt drains (116) into the heater which contains an 85% level in the bath, 204. The remaining 15% forms a space to collect CO₂ when it is desorbed from the Li₂CO₃ contained in the salt. A drain, 116, from the tower to the heater is through a pipe that exits below the salt level which acts as a seal to prevent CO₂ from escaping back into the tower.

The fire tube heater 202 is a horizontal vessel with the fire tube, 212, submerged in the salt. It provides heat to the salt to increase the temperature 200-400° F. above the absorption temperature of the tower for regeneration. The fire tube is heated by burning fire tube burning gas, coal or oil that enters through conduit 214 (air through conduit 216) Both fuel and air are preheated by exchange with the exhaust. Exhaust from the fire tube containing CO₂ is directed into the scrubber tower by conduit 212 where it mixes with the incoming flue gas and the CO₂ is removed. Temperature is maintained at about 1300° in the top section of the regenerator scrubber and is cooled to 800-1100° in the bottom section by internal or external exchangers 216, prior to being pumped, 107, to the top of the spray tower to repeat the cycle. CO₂ desorbed by heat in the heater flows out the top at near 1300° and goes through an exchanger, 206 with incoming fuel gas. The gas is expanded in the exchanger to provide cooling to the CO₂ prior to being compressed. This method of using heat directly instead of first producing steam, as with amine, is much more efficient.

The molten salt bath, 220, is composed, in one embodiment, of a ternary mixture of about 42% Li₂CO₃, 29% K₂CO₃ and 29% Na₂CO₃ and has a melting point of 750°. Other mixes can also be used, as for example between 30 and 60% Li₂CO₃ and the remainder split between K₂CO₃ and Na₂CO₃. The mix is melted and the temperature increased to about 1000°. Four (4) percent silicon dioxide (SiO₂) ground to 15 nano meters is added to the bath which is kept stirred because the SiO₂ will not melt and remains as a slurry. The temperature is increased to about 1650° over a 3 hour period and held at 1650° for 4 hours in order for 8% of the Li₂CO₃ in the melt to react with the SiO₂ to form Li₄SiO₄. This prepares the bath for CO₂ absorption. The temperature is brought to 1300° in the regenerator, cooled to 950° by the exchanger and pumped to the top of the tower, 102, to begin absorption. The slurry is kept in suspension by the pumping action. The exhaust from the fire tube provides heat for the tower at startup and to maintain the molten pool in the bottom.

### Static Mixer Embodiment

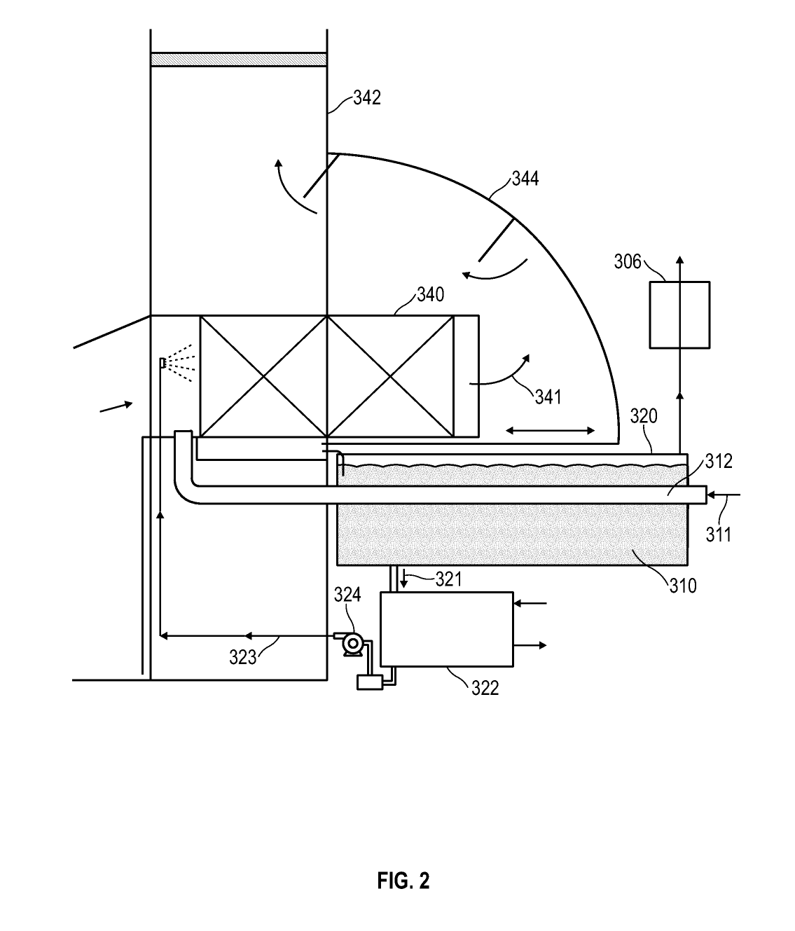

The configuration shown in the FIG. 1 contains a scrubber tower. A static mixer such as those made by Komax Systems, Inc. (www.komax.com/Gas-Liquid-Contacting.html) is also suitable and may be preferred in some installations. An embodiment using a static mixer is illustrated in FIG. 2. Referring to FIG. 2, a static mixer 340 is used to mix the CO₂ containing gas with the salt may be used instead of or in addition to the scrubber as explained more fully below. Flue gas from a boiler, furnace or gas turbine or any gas contaminated with CO₂ enters mixer at point 345 where it is mixed with salt containing Li₄SiO₄ to absorb the CO₂ in the gas. The effluent passes out of the mixer at 341 and out stack 342. Li₄SiO₄ within in the salt absorbs the CO₂ and falls to the salt pool, 343. A salt bath heater, 320, is joined to the mixer vessel in such a way that the salt drains from the salt pan 343 into the heater which contains an 85% level in the bath, 310. The remaining 15% forms a space to collect CO₂ when it is desorbed from the Li₂CO₃ contained in the salt. A drain, 116, from the salt pan to the heater is through a pipe that exits below the salt level which acts as a seal to prevent CO₂ from escaping back into the tower.

The fire tube heater 310 is a horizontal vessel with the fire tube, 312, submerged in the salt. It provides heat to the salt to increase the temperature 200-400° F. above the absorption temperature of the mixer for regeneration. The fire tube is heated by burning gas, coal or oil that enters through conduit 311. Both fuel and air are preheated, by exchange with exhaust. Exhaust from the fire tube containing CO₂ is directed into the mixer vessel 340 by conduit 312 where it mixes with the incoming flue gas and the CO₂ is removed. Temperature is maintained at about 1300° in the top section of the regenerator and is cooled to 800-1100° in the bottom section by internal or external exchangers 322, prior to being pumped, 324, to the mixer vessel to repeat the cycle. CO₂ desorbed by heat in the heater 310 flows out the top at near 1300° and goes through a exchanger, 306 with incoming fuel gas. The gas is expanded in the exchanger to provide cooling to the CO₂ prior to being compressed. The molten salt bath is the same as described above for the scrubber tower mode of operation.

The processes have been described for removal of CO₂ form flue gas; however there are many other sources of CO2 pollution other than flue gas. For example, in the production of hydrogen 95% is by the steam methane reforming (SMR) process. This involves two avenues of pollution. First the steam and methane are heated in a furnace tube and the flue gas from the furnace is expelled to the atmosphere. Then the heating reaction inside the tube produces hydrogen and CO₂. For the hydrogen to be useful the CO₂ has to be removed which is done by the traditional amine process and the CO2 released to the atmosphere.

### Hydrogen Production

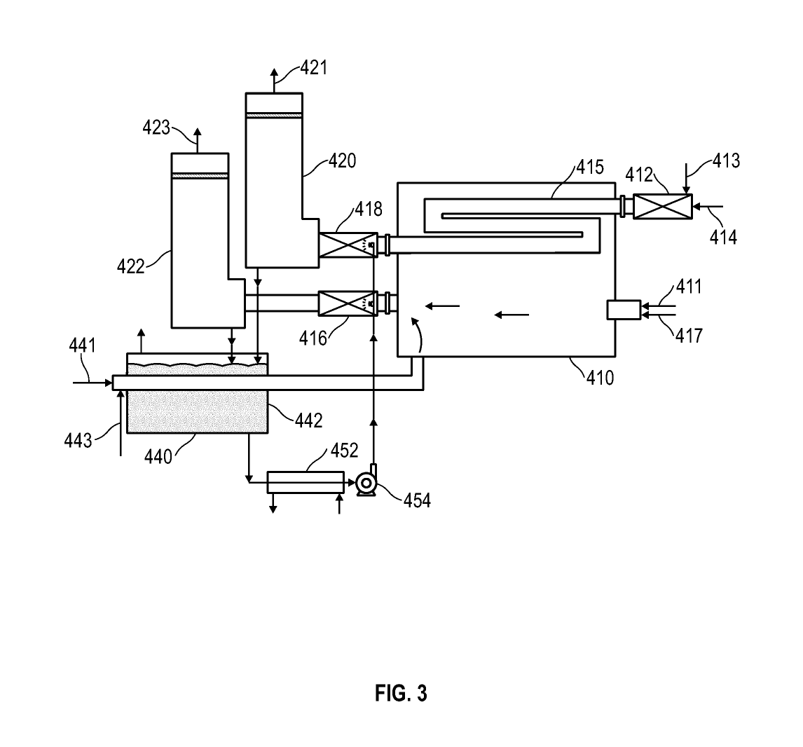

The process as described above can be adapted to produce hydrogen cleanly. FIG. 3 illustrates an embodiment of the process for hydrogen production. Steam and hydrocarbon (413 and 414) are mixed in a static mixer 412 before entering a furnace tube, 415 where the temperature inside the tube is between 1600°-1850° F. At this temperature steam and hydrocarbon cannot exist—they form H₂ and CO₂. As the gas exits the tube it goes through a mixer, 418, where the salt (from pump 454) contacts the gas as previously described, to remove the CO₂. H₂ exits the vent 421. The flue gas from the furnace containing N₂ and CO₂ exits the furnace through another outlet and enters another mixer, 416, where salt (vessel 422) removes the CO₂ and allows N₂ to exit the vent 423. The molten salt is regenerated in a fire tube heater 440 as previously described. Coal can be converted to hydrogen in the furnace just like hydrocarbons. The preferred method is to form a water slurry with the coal, and the finer ground the particles are the better the reaction rate. If coal is used the particles and sulfur have to be removed first by traditional processes such as bag houses, precipitators or spray towers. NOx is not a problem as it is decomposed by the molten salt and therefore cannot contribute to ozone pollution.

Other processes can be adapted to eliminate CO₂ pollution such as lime kilns and effluent from steel mills. After sulfur and particulates are removed the gas is conducted through the same system of gas mixers as the previous description. This also applies to coal burning power plants which can be retrofitted to remove CO₂ after they have already removed sulfur and particulates.

In the foregoing specification, the invention has been described with reference to specific embodiments thereof. It will, however, be evident that various modifications and changes can be made thereto without departing from the broader spirit and scope of the invention as set forth in the appended claims. The specification is, accordingly, to be regarded in an illustrative rather than a restrictive sense. Therefore, the scope of the invention should be limited only by the appended claims.

1. A process for capture of carbon dioxide from gases comprising contacting a CO₂ containing gas with Li4SiO₄ contained in a molten salt mixture at a temperature of about 800-1200° F. and a Li₄SiO₄ content in the molten salt mixture of about 1-30% and recovering the CO₂ captured by the Li₄SiO₄ by heating the salt to 1300° F.

2. The process of claim 1 wherein the molten salt contains salts selected from the group consisting of Li₂CO₃, K₂CO₃, Na₂CO₃, CaCO₃, Mg₂CO₃ and mixtures thereof.

3. The process of claim 1 wherein the molten salt contains salts selected from the group consisting of LiCl, KCl, NaCl, CaCl and mixtures thereof.

4. The process of claim 1 wherein the molten salt mixture is a ternary salt mix consisting of about 42% Li₂CO₃, 29% K₂CO₃, 29% Na₂CO₃ and wherein the salt mixture is heated to its melting point or above and about 4% SiO2 added to the mix and heating the mix to about 1650° F. so that the SiO₂ and about 8% of the Li₂CO₃ react to form Li₄SiO₄.

5. The process of claim 1 wherein CO₂ captured by the Li4SiO₄ is released by heating the molten salt to about 1300° F. or above.

6. The process of claim 1 wherein the Li4SiO₄ contained in a molten salt mixture is injected into a vessel in a manner that forms a liquid phase of fine droplets or mist at a temperature of 600°-1200°.

7. The process of claim 6 wherein the gas containing CO₂ is injected into the vessel and allowed to flow through the phase of fine fluid droplets or mist so that CO₂ in the gas contacts the Li4SiO4 in the fluid droplets and reacts to form Li₂SiO₃+Li2CO₃, a slurry that falls with the fine droplets to the bottom of the vessel and is withdrawn.

8. The process of claim 7 wherein, as 1-2-3 the pool of liquid at the bottom of the vessel is drained into an adjoining vessel, the temperature increased to about 1300° F. or above to cause CO₂ contained in the Li₂CO₃ to decomposed back to Li₄SiO₄ and CO₂.

9. The process of claim 7 whereby the exhaust from the fire tube provides startup heat for the tower and maintains reaction heat to the liquid salt.

10. A process for producing hydrogen from hydrocarbons or coal comprising reacting steam and hydrocarbon at conditions that convert them to hydrogen and CO₂; contacting the CO₂ containing gas so formed with Li₄SiO₄ contained in a molten salt mixture at a temperature of about 800-1200° F. and a Li₄SiO₄ content in the molten salt mixture of about 1-30% and recovering the CO₂ captured by the Li₄SiO₄ by heating the salt to 1300° F.

11. The process of claim 10 wherein the molten salt contains salts selected from the group consisting of Li₂CO₃, K₂CO₃, Na₂CO₃, CaCO₃, Mg₂CO₃ and mixtures thereof.

12. The process of claim 10 wherein the molten salt contains salts selected from the group consisting of LiCl, KCl, NaCl, CaCl and mixtures thereof.

13. The process of claim 10 wherein the molten salt mixture is a ternary salt mix consisting of about 42% Li₂CO₃, 29% K₂CO₃, 29% Na₂CO₃ and wherein the salt mixture is heated to its melting point or above and about 4% SiO₂ added to the mix and heating the mix to about 1650° F. so that the SiO₂ and about 8% of the Li₂CO₃ react to form Li₄SiO₄.

14. The process of claim 10 wherein CO₂ captured by the Li4SiO₄ is released by heating the molten salt to about 1300° F. or above.
